(19) United States
(12) Patent Application Publication
(10) Pub. No.: US 2003/0028900 A1
(43) Pub. Date: Feb. 6, 2003

(54) IRD with answering machine and remote recording event programming

(76) Inventor: Michael Kahn, Westampton, NJ (US)

Correspondence Address: RATNERPRESTIA, P O BOX 980, VALLEY FORGE, PA, 19482-0980, US

(21) Appl. No.: 09/909,179

(22) Filed: Jul. 19, 2001

(51) Int. Cl. H04N 9/00; H04N 11/00; H04N 5/91; H04N 7/00; H04N 7/173; H04N 7/16

(52) U.S. Cl. 725/133; 725/141; 725/153; 386/1; 386/46

(57) ABSTRACT

A video recorder programming device has a telephone interface and includes telephone answering machine functionality and video recorder programming functionality. The device operates, by default, as a telephone answering machine. When a user enters a programming code using the telephone keypad, the device switches to a video recorder programming mode and prompts the user to enter a channel number, start time and a stop time or duration. The device stores the received programming data and, in the programming mode, allows the user to edit or delete the stored data.

### FIELD OF THE INVENTION

The present invention relates to the field of video recorder device programming and, more particularly, to a set-top box with the capability of receiving and transmitting program data for a video recorder to a remote user.

### BACKGROUND OF THE INVENTION

In common use today is a set-top box used to control reception and display of video data. Also common today is programming of video recorder devices. While there is still a large installed base of set-top boxes designed to receive only analog signals, set top boxes designed to receive digital signals are becoming more popular. Furthermore, not only are digital signals received via satellite systems, cable systems are upgrading to the transmission of digital signals in greater numbers.

Most currently available set-top boxes are equipped with a feature that allows the set-top box to make outgoing telephone calls through a telephone port. This port is always connected and is used, for example to telephone the service provider to download billing information or to request pay-per-view programming.

This telephone connection may also be used to program a device, for example, a VCR, to record a particular program from a remote location. An example of a programming device using an ordinary telephone connection is disclosed by Hashimoto in U.S. Pat. No. 5,420, 913. A common telephone is linked through the device to a video recorder. A user may call the telephone from a remote site and, using telephone keypad at the remote site, enter PlusCodes or other reservation codes into the recording device, which may or may not be in the set-top box. As such, this invention may require special hardware for implementation. Also, a user can only program the recorder device with the codes. Should a user not know the code of the show he or she is seeking, or if the user wishes to program a device to start or stop recording at some time other than that specified by the code, this device cannot be used.

### SUMMARY OF THE INVENTION

It would be advantageous to incorporate an answering machine into the set top box. In that manner, the answering machine would be able to “answer” the telephone and interact with the remote user. In a special mode, the user can remotely check the status of pending programs and can program either the box or an associated video recorder to start and stop at any time. Furthermore, off-the-shelf components can be used to construct the device. Therefore, there is a need for a set-top box with answering machine functions so that a user may program the set-top box or associated video recorder without the need for special equipment. Also, the user may program his audio/video equipment from any location where a telephone is available.

The present invention includes a method and apparatus for programming a video recording device from a remote location. The device includes a microprocessor, an infrared signal transmitter electrically coupled in the microprocessor, a telephone answering device, and a memory device. A user can call the programming device through the telephone device and enter a code through a telephone key pad which puts the device in programming mode. The microprocessor then takes control from the answering device and, using the telephone key pad, a user can enter commands that the microprocessor understands as programming commands. These commands can be stored and/or transmitted to a video recorder for processing.

### BRIEF DESCRIPTION OF THE DRAWING

FIG. 1 is a block diagram of an exemplary embodiment of the present invention.

FIG. 2 is a block diagram of an IRD of an exemplary embodiment of the present invention.

FIG. 3 is a block diagram of an answering machine module in an exemplary embodiment of the present invention.

FIG. 4 is a block diagram of an infrared control module in an exemplary embodiment of the present invention.

FIG. 5 is a flow chart of an exemplary embodiment of a programming mode of the present invention.

FIG. 6 is a flow diagram of an exemplary embodiment of an EP program mode of the present invention.

FIG. 7 is a flow diagram of an exemplary embodiment of an EP delete mode of the present invention.

FIG. 8 is a flow diagram of an exemplary embodiment of an EP edit mode of the present invention.

### DETAILED DESCRIPTION OF THE INVENTION

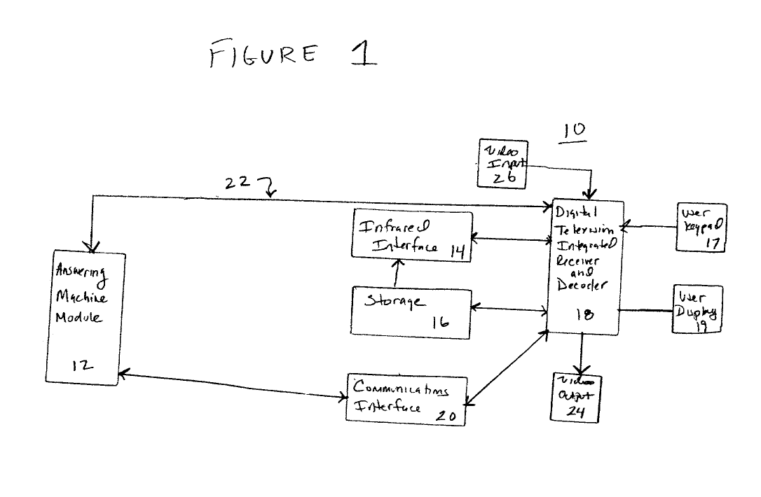

FIG. 1 shows a high level block diagram of an exemplary embodiment of a set-top box (STB) 10 according to the present invention. The STB 10 includes an answering machine module 12, an infrared interface 14, a memory 16, a digital television (DTV) integrated receiver/decoder (IRD) 18, a control keypad 17, a display 19, a communications interface 20 and a video output port 24 and a video input port 26. The answering machine module 12 performs basic answering machine functions such as on-hook and off-hook detection, greeting message playback, message recording and message playback. Linked to the answering machine module 12 by a control bus 22 is the digital television IRD 18. The IRD performs the functions required to receive and display a digital television signal. Typically, these functions include receiving a digital signal, performing all required signal conditioning, and transmitting a display signal to a display device such as a television monitor (not shown).

The IRD 18 also controls the programming function of the set-top box 10. The infrared interface 14 is linked to the IRD 18 and functions as a transmission device to transmit programming commands to a VCR or other video recording apparatus that has the ability to receive coded IR signals from a remote device. The infrared interface 14 may be, for example, an IR blaster such as used by VCR plus® units. Storage 16 is internal storage such as a magnetic disc, SD memory modules, or some other form of non-volatile memory. Preferably, storage 16 is a high capacity device. Storage 16 may store command functions for the infrared interface 14 only or, in an alternative embodiment, may record the requested television program in the manner of a personal video recorder such as that manufactured, for example, by REPLAY TV. The answering machine module 12 and the IRD 18 communicate to a user via the communications interface 20 which, in an exemplary embodiment, may be a standard serial or parallel communications port as used in any common personal computer. Also, the STB 10 includes an industry standard video input port 26, for receiving video from a cable provider, satellite system or video playback device, and an industry standard video output port 24 for transmitting a video signal to a display device or a recording device.

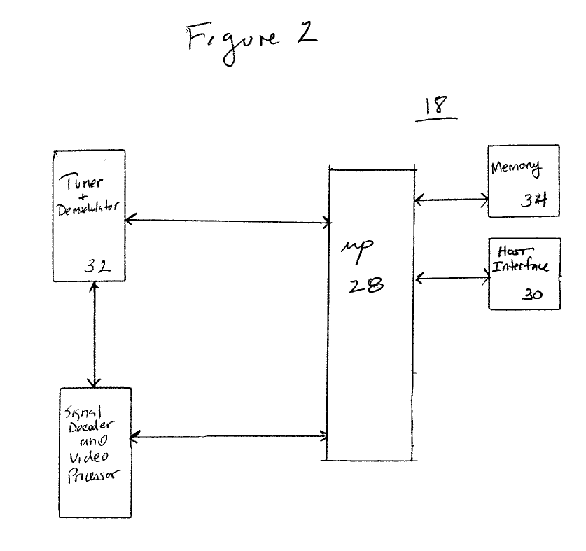

FIG. 2 is a block diagram of an exemplary embodiment of the IRD 18 of the set-top box of the present invention. The primary microprocessor 28 performs all of the basic computing and control functions required for operation of the STB 10. In this exemplary embodiment, the microprocessor 28 receives and transmits data through the host interface 30. In the exemplary embodiment of the invention, the host interface 30 may be, for example, an IEEE 1394 “firewire” bus. This information may include, for example, control signal data received from the answering machine module 12. This information may also includes programming received from the video recording device via the 1394 bus or data transmitted to the recording device via the IR interface 14. Alternatively, the IR interface may be coupled to the microprocessor 28 directly. Of particular interest to the present invention, when the answering machine module 12 receives the proper code, the system is placed in event programming (EP) mode.

The module 12 passes control to the IRD 18, at which time the primary microprocessor 28 then prompts the user through the telephone connection for programming data. The microprocessor 28 receives the data, processes it and transmits it to memory 34 where the data is stored. In an alternative embodiment, the processed programming data may be transmitted directly back through the host interface 30 or to the IR interface 14, where the data is broadcast to a video recording device via the IR blaster. When the programming data is stored, the microprocessor 28 determines when the start time and date contained in the programming data equals the present time and date and sends a message with the appropriate tuning and recording commands for the VCR or other recording device to the host interface 30 or to the infrared interface 14. Alternatively, the microprocessor 28 may send a command to the tuner and demodulator 32 of the IRD 18 to tune to the proper channel and provide the received signals to the recording device through the video output port 24 or to the storage module 16 of the STB 10 (shown in FIG. 1).

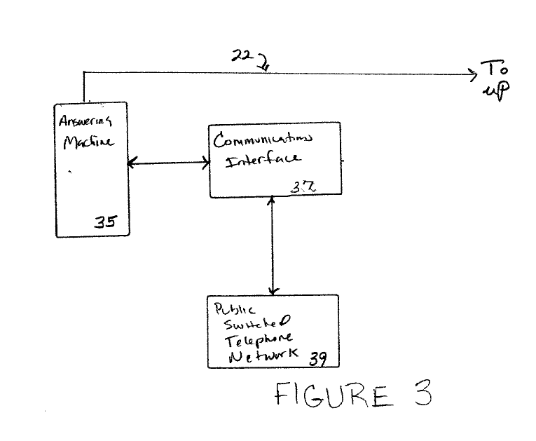

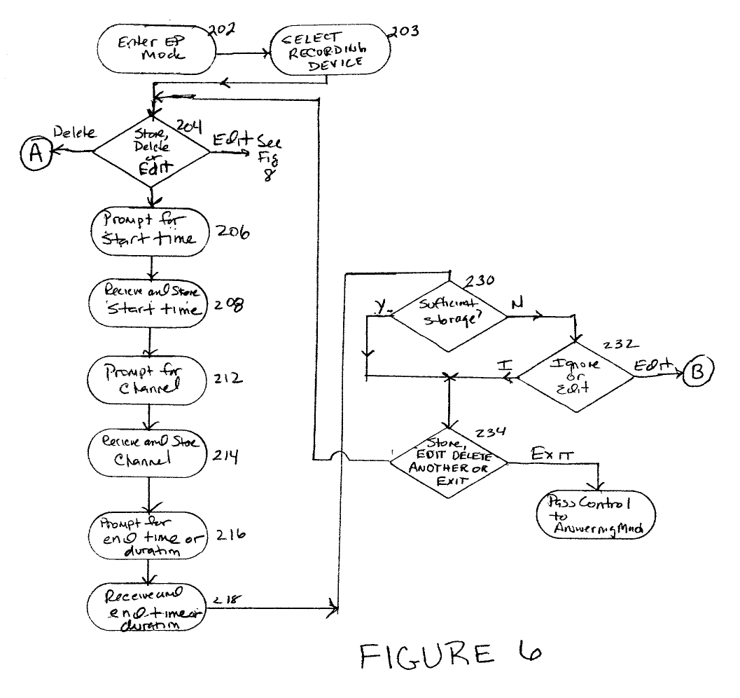

FIG. 3 is an exemplary embodiment of the answering machine module 12 of the present invention. The module 12 contains an answering machine 35 which has a communication interface 37 coupled to an industry standard public switched telephone network (PSTN) 39. The module 12 functions in the following manner: When a user connects to the answering machine 35 through the PSTN, the answering machine 35 senses the ring signal, places the answering machine in an off-hook condition, and sends the greeting message. While sending the greeting message, the answering machine 35 is also waiting to receive the event programming (EP) code. Once the user enters the EP code, the answering machine passes control to the IRD 18 and the system is put in event programming mode (EP mode). Otherwise, the answering machine 35 continues as an industry standard answering machine. The operation of the system in EP mode is described below with reference to FIGS. 6, 7 and 8.

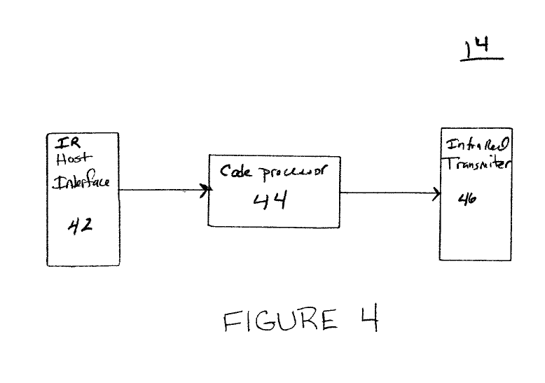

FIG. 4 is an example of an embodiment of the infrared interface device 14 of the present invention. The IR host interface 42 receives programming data from the IRD 18 and sends the data to the code processor 44. The code processor 44 may contain, for example, product codes and corresponding infrared pulse patterns for many commercially available video recorder devices with IR interfaces. The programming data is converted to the proper infrared pulses for the selected device which are broadcast to the video recorder via the infrared transmitter 46. The infrared transmitter 46 is placed in a direct line of sight to the infrared receiver of the video recording device so that the video recording device may be controlled by the infrared pulses. In an alternative embodiment, if the infrared interface 14 is an IR blaster, the infrared receiver need not be in direct line of sight.

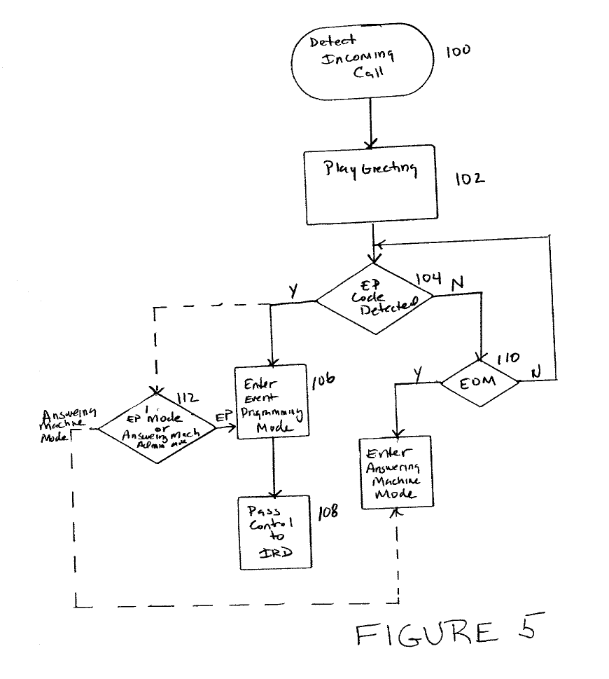

FIG. 5 is a flow diagram that is useful for describing an exemplary embodiment of the communication function of the present invention. At step 100, the answering machine detects an incoming call. At step 102 the call is answered and the answering machine plays a normal answering machine greeting. At step 104 the answering machine determines if the event programming code has been detected while or after the greeting was played. In the exemplary embodiment of the invention, the event programming code is a specific sequence of dual-tone multi-frequency (DTMF) tones, for example, “#*#.” The code may be entered by the remote user on the telephone keypad.

If, at step 104, the event programming code is detected, at step 106 the answering machine unit transmits a signal to the microprocessor to enter event programming mode and, at step 108, passes control to the IRD 18. If no event programming code is detected at step 106 then, at step 110 the answering machine determines if the end of message has been played. If not, the answering machine unit returns to step 104 and continues “listen” for an EP code. When the end of message code is been detected at step 110, step 112 the answering machine unit may wait, for example, for a short interval (e.g. two (2) seconds) before continuing. After the delay, if no EP code is detected, the answering machine unit functions strictly as a standard answering machine. It may, for example, prompt the user to leave a message or enter a code to place the answering machine into answering machine administrative mode, allowing the user to retrieve messages or perform administrative functions.

In an alternative embodiment, once the EP code is detected, the system prompts the user to enter a code for programming mode or another code for answering machine administrative mode, so that a user need not wait for the end of the greeting message to enter answering machine administrative mode.

FIG. 6 is flow-chart diagram of an exemplary embodiment of the EP store program mode of the present invention. At step 202, the answering machine module 12 detects the EP code entered by the user, and the system enters EP mode. At step 203, the user selects the device to be programmed as the user may have multiple recording devices, for example, a VHS VCR, a digital VCR (DVCR), or a personal video recorder. At step 204, the user is prompted to indicate an action, for example, store a new program, delete a program or review and edit a program. The prompts may be accomplished, for example, by a speech synthesizer (not shown) in the answering machine module 12 which announces the choices in a menu format.

If, at step 204, the user has selected the store option, then, at step 206, the system prompts for a start time for recording. The user then enters the requested data on the telephone keypad. The system 10 detects the DTMF codes, converts the DTMF into programming data, and, at step 208 receives and stores the data in memory. At step 212, the system prompts for a channel to be recorded. In the same manner as step 208, at step 214 the system receives and stores the programming data. In the same manner as the start time and channel data, at steps 216 and 218 the system prompts the user for a stop time. In an alternative embodiment, instead of a stop time, the user may enter a time for duration of the recording. Time may be entered in one of two ways; either hour, minute and am/pm, or in military form, such as x00 hours.

In order to allow programming of events that will occur on future days, months or years, and also to limit programming steps, the system 10 interprets data entered in response to a time prompt, and uses certain defaults. If only a time is entered, the day, month and year defaults to the next available day for the time specified. For example, if 0800 is entered by the user at step 206, and the entry is made at 1000 hours, the system interprets the time as 8:00 am the next day. Alternatively, if 0800 is entered by the user, and the entry is made at 0600 hours, the system interprets the time entered as 8:00 am on the day the time was entered. Furthermore, if time and date are entered, but not month and year, the current month and year are assumed. Lastly, if time, date and month are entered without a year, the current year is assumed.

At step 230 the system then determines if there is sufficient storage space to store the required program. Prior to using the system, a user can input, through the front panel controls 17, a code which identifies the connected storage device and, if necessary, the recording mode. From this, the system can determine how many total minutes of video information can be stored. As each program is entered, the system can determine how many total minutes are available on the recording medium, and can inform the user if the total capacity is exceeded. If the STB 10 is coupled to the recording device by a control bus such as the IEEE 1394 bus, the available amount of time can be determined by interrogating the recording device. Otherwise the amount of time can be estimated if, for example, the user resets a counter in the STB for the recording device when the tape is rewound. By default, the system records the requested programming on the VCR or other external video recorder. If the tape in the VCR is full, the system may record the requested video programming on the mass storage 16 (shown in FIG. 1). The user can also select to record over video data in the mass storage, or to append only. Although not shown in FIG. 6, if the maximum capacity is exceeded by the program request, the user can choose to rewind the tape to record over previously recorded material or may edit existing programs for the recording device to correct the condition at step 232.

Once the programming sequence is complete, at step 234, the user is prompted either to continue in EP mode, or exit. Once the user exits, control of the communication is passed back to the answering machine module 12. Furthermore, an escape code, such as “##”, may be used at anytime in EP mode to return the user to step 202. Another escape code may be used at anytime to return the user to answering machine mode.

In this exemplary embodiment, the programming data is stored and transmitted, as a serial string of data. An exemplary embodiment of the timer message format may be as follows: sttttmmddyyyyzaaaacxxxx. In this implementation, the string “sttttmmddyyyy” signifies start time data, with the time in military form, followed by the month day and year. “zaaaa” signifies duration of the recording as “aaaa” minutes. The “cxxxx” represents the channel number “xxxx.”

Alternatively, the timer message could be: sttttmmddyyyyzttttmmddyyyycxxxx, where “s” and “c” are the same as above, but “z” would be end time, and is represented similar to the start time. As an exemplary embodiment, s080001012002z0300c0100 represents a program code of: start recording on Jan. 1, 2002 at 8:00 am, record for 300 minutes and record channel 100.

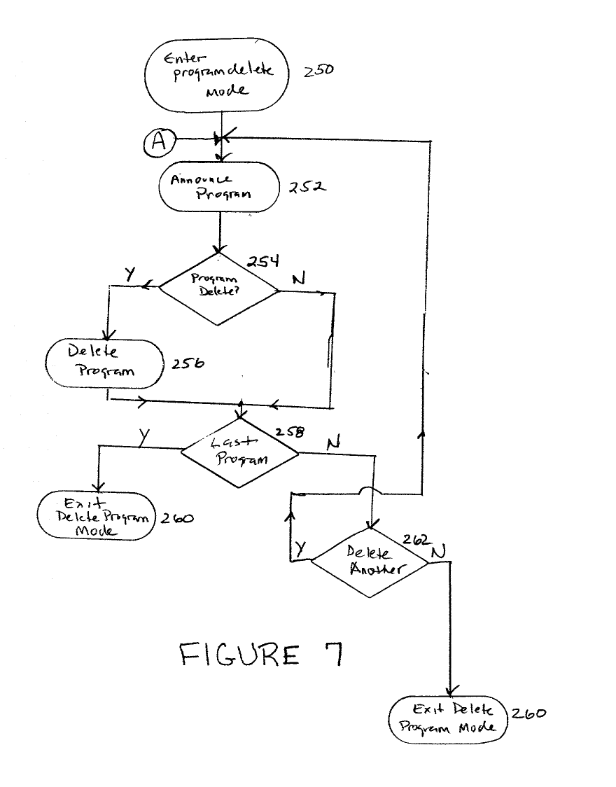

As shown in FIG. 6, at step 204, the system prompts a user to indicate if a record program, delete program or edit program mode is required by pressing, for example, the “7” key for record, the “3” key for delete and the “*” key for edit. If the delete function is selected, the unit is placed in the delete program mode, as shown in the exemplary flow-chart diagram of FIG. 7. At step 250, the system enters program delete mode. At step 252, using the speech synthesizer, the system announces each program that is stored in memory. For example, a typical announcement may be “program 1, channel 35, start time 1:00 p.m., end time 3:00 p.m.” At step 254, after each program the user may be prompted to indicate if the program is to be deleted. A typical prompt may be, for example, “Delete this program? Press “9” for yes, “6” for no.” If the user selects the proper key for “yes” on the telephone keypad, the program is erased at step 256. If the program was not stored but was broadcast to the recording device using the IR blaster, the IR blaster may be used to send commands to the recording device to cancel the prior commands. If, at step 254, the user indicates “no” or after the program has been deleted at step 256, then, at step 258, the system determines if there are any other programs to announce. If the last program had been announced, the system exits EP delete mode at step 260. If there are other programs in memory that have not been announced, at step 262 the system prompts the user if the user would like to delete another program. If “yes”, the system returns to step 252. If no, the system exits EP edit mode and return to the “enter, delete or edit program” step, 204.

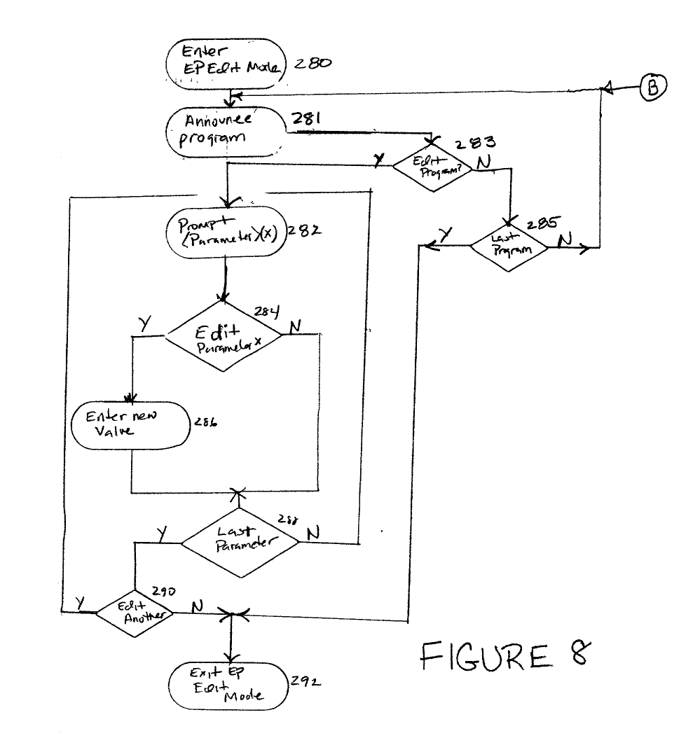

If the edit program selection is made at step 204 in FIG. 6, the system enters an EP edit mode. An exemplary embodiment of the EP edit mode is shown in the flow-chart diagram of FIG. 8. At step 280 the system enters EP edit mode. Similar to the EP cancel mode described above and illustrated in FIG. 7, at step 281 the system announces each program to the user. At step 283, the system prompts the user to indicate if the user desires to edit the announced program. If “no”, the system determines if there are any other programs which have not been announced and, either returns the user to step 281, or exit EP edit mode at step 292.

If the response to step 283 is “yes”, at step 282 the system announces each parameter of the program and prompts the user, after each announcement, to indicate if the user wishes to edit the announced parameter. The parameters are, for example, start time, end time, date and channel, for each program. If a “yes” response is received, at step 286, the system prompts the user for a new value for the announced parameter and update the memory accordingly. If “no”, and after each edit, at step 288, the system determines if it has prompted for all the parameters of program. If not, the system returns to step 282 to continue prompting the user. When the last parameter is reached, at step 290, the system prompts the user to indicate if another program is to be edited. If yes, the system returns to step 282 to continue to the next parameter, until all parameters are prompted for each program. If the user enters “no” at step 290, the system exits EP edit mode at step 292.

Although not described above, it is contemplated that the IRD 18 may confirm any entry made by the user immediately after that entry is made by converting the entry to speech and asking the user to confirm that the entry is correct. In addition, although the described embodiments allow the user to enter only the channel number, the start time and the stop time or duration, it is contemplated that other commonly used options may be added to the list of parameters, for example, recording speed and whether the program is a weekly program, a daily program or a single event.

In an alternative embodiment, the user may enter EP edit mode or EP cancel mode after each program is announced. In this manner, the system can inform the user of the parameters of each program and allow the user to select whatever EP function the user requires for each program.

Although the invention has been described in terms of exemplary embodiments, it is contemplated that it may be practiced as described above with variations that are within the scope of the following claims.

What is claimed is:

1. A video recorder programming device comprising:
means for communicating between a user and said video recorder programming device through a telephone connection;
means for storing audio messages transmitted by said user through said means for communicating;
means for receiving and storing recording parameter data transmitted by said user through said means for communicating;
means for starting a recording process by a video recorder responsive to the stored parameters.

2. A device according to claim 1, wherein the means for starting the recording process comprises an infrared signal transmitter that transmits a command to the video recorder causing the video recorder to enter a programming mode, transmits the parameters to the video recorder as the program and transmits a command to the video recorder to leave the programming mode.

3. A device according to claim 1 wherein the parameters include a channel number and a start time, and the device further comprises a television receiver and decoder including a television tuner for tuning to the channel specified by the channel number at a time equal to the start time to receive and decode a television signal corresponding to the parameters, whereby the video recorder records the decoded television signal.

4. A device according to claim 3, wherein the device further comprises a mass storage device and the means for starting the recording process causes the decoded television signal to be stored in the mass storage device as the video recorder.

5. A device according to claim 1, wherein the means for storing audio messages comprises a telephone answering machine.

6. The device of claim 5, further comprising means, responsive to a predetermined dual-tone multi-frequency (DTMF) code for switching the device between operating as the telephone answering machine and as the video recorder programming device.

7. A method of programming a video recording device comprising:
enabling telephone communications between a user and a set top box;
transmitting audio data to the user to prompt the user to transmit audio programming data including start time data and one of stop time data and duration data;
receiving the audio programming data into the set top box through said telephone communications and converting the audio programming data into command data for the video recording device;
transmitting the command data to the video recording device.

8. A method according to claim 7, wherein the set-top box further includes telephone answering machine functionality and the method further comprises the step of receiving predetermined audio data to switch the set-top box from the answering machine functionality prior to receiving the audio programming data.

9. A method according to claim 7, wherein the step of transmitting the command data to the video recording device includes converting the command data into infra-red signals and transmitting the infra-red signals to the video recording device.

10. A method according to claim 7, further including the step of storing the command data in the set top box.

11. A method according to claim 10, wherein the step of transmitting audio data to the user includes the steps of prompting the user to select between entering new programming data, deleting existing programming data and editing existing programming data and the step of receiving the audio programming data includes modifying the stored command data responsive to audio programming data received through the telephone communications.

12. A method of programming a video recorder, said method comprising:
detecting an incoming telephone call by a set top box containing an automated answering machine;
enabling telephone communication between a user and said set top box;
transmitting a message from said automated answering machine to said user;
detecting a programming signal transmitted by said user through said telephonic communication to said automated answering machine,
receiving programming data into said automated answering machine, said programming data being transmitted by said user through said telephone communication and including start time data and at least one of stop time data and duration data,
transmitting said programming data and a control code from said automated answering machine to said video recorder to enable a recording function of said video recorder.

13. The method of claim 12, further comprising storing said programming data into a data storage device.

14. The method of claim 12, wherein the step of transmitting the programming data to the video recorder further includes the step of converting the programming data into an infrared signal.
